(19) United States
(12) Patent Application Publication
(10) Pub. No.: US 2011/0081211 A1
(43) Pub. Date: Apr. 7, 2011

(54) Tool and inserts for milling splines

(76) Inventors: Laszlo Frecska, Spring Grove, IL (US); James T. Hartford, Silverlake, WI (US)

(21) Appl. No.: 12/928,088

(22) Filed: Dec. 4, 2010

Related U.S. Application Data
(63) Continuation-in-part of application No. 12/317,735, filed on Dec. 29, 2008.

(51) Int. Cl. B23C 5/22; B23C 5/12

(52) U.S. Cl. 407/49; 407/113; 407/51

(57) ABSTRACT

The invention discloses an improved tool and inserts for concurrently milling multiple splines on a round (rod) material. Replaceable inserts having teeth formed to have their cutting edges shaped in the arc of a circle are disclosed. The inserts each include at least two sets of rough milling teeth. The tool holder shank includes recesses which provide a common or universal unit for receiving various sized groupings, each comprising an insert, a wedge for securing the insert, and a supporting member for the insert.

This application is a continuation-in-part of U.S. patent application Ser. No. 12/317,735 filed on Dec. 29, 2008, titled “Universal Tool and Inserts for Milling Splines” and filed in the names of Laszlo Frecska and James T. Hartford, the same inventors herein. Applicant hereby claims the benefit of the earlier filing date of the above cited application under 35 U.S.C. 120 and 37CFR 1.78.

### BACKGROUND OF THE INVENTION

Splines normally comprise grooves and ridges formed on the periphery of a shaft/rod which series of grooves and ridges extend parallel to one another and parallel to the axis of the shaft. Referring briefly to FIG. 8 of the attached drawings, ridges or teeth of the splines on the mesh with grooves on a mating piece and transfer torque thereto. Importantly, the grooves and ridges of a spline must be identical i.e., all the grooves must be of the same depth and of the same width to properly function with the mating splines, and the ridges and grooves of splines extend parallel to the axis of the workpiece. For example referring briefly to FIG. 8 of the present application, the ridges and grooves of splines 33 on rod 30 engage mating splines of a cylinder 38 to transfer torque thereto.

In the prior art, splines have been milled by cutting or milling one spline at a time, that is cutting one spline groove during one pass of the cutting insert or blade, as depicted in FIG. 9 of the present application. Since the splines had to be identical, the method of making one groove during each pass of the same cutting tool was considered as the way to make industrially useful splines.

### SUMMARY OF THE INVENTION

The invention discloses an improved tool and inserts for concurrently milling multiple splines on a round (rod) material. Replaceable inserts having teeth formed to have their cutting edges shaped in the arc of a circle are disclosed. In use, the inventive inserts are mounted on the tool holder of a thread milling tool; the tool holder includes an elongated mounting recess for accommodating the inserts. In a preferred embodiment the inserts multiple sets of cutting teeth; the first set of teeth is for rough milling the metal, the second set is essentially a duplicate of the first set to provide a double or extended use of the insert, and the third set of teeth provides the finished milling. The tool includes selected recesses around its periphery to accommodate respective groups of inserts, their support members and wedges to provide a universal tool adapted to receive various different inserts.

The foregoing features and advantages of the present invention will be apparent from the following more particular description of the invention. The accompanying drawings, listed herein below, are useful in explaining the invention.

### DRAWINGS

FIG. 1 is a view of the inventive thread milling tool and inventive inserts mounted on the tool;

FIG. 2 is an end view of the inserts mounted on the thread milling tool;

FIG. 3 is and end view showing splines threaded on a round shaft or rod;

FIG. 4 is a side view of an insert to show three sets of teeth on the insert;

FIG. 5 shows a wedge used in mounting the inserts;

FIG. 6 shows the support used in mounting the inserts on the thread milling tool;

FIG. 7 is an isometric view of the inserts mounted on the thread milling tool;

FIG. 8 is an isometric view of an involute spline being inserted into an associated hollow cylinder;

FIG. 9 is view depicting a standard prior art method of cutting involute splines;

FIG. 10 in cross section view of depicting the position of a wedge to show the grasping action of the wedge on the associated insert;

FIG. 11 depicts another embodiment of the insert that includes two keying slots that enables the insert to be used in a reversed position; and

FIG. 12 depicts the inventive tool and insert cutting multiple splines.

### DESCRIPTION OF THE INVENTION

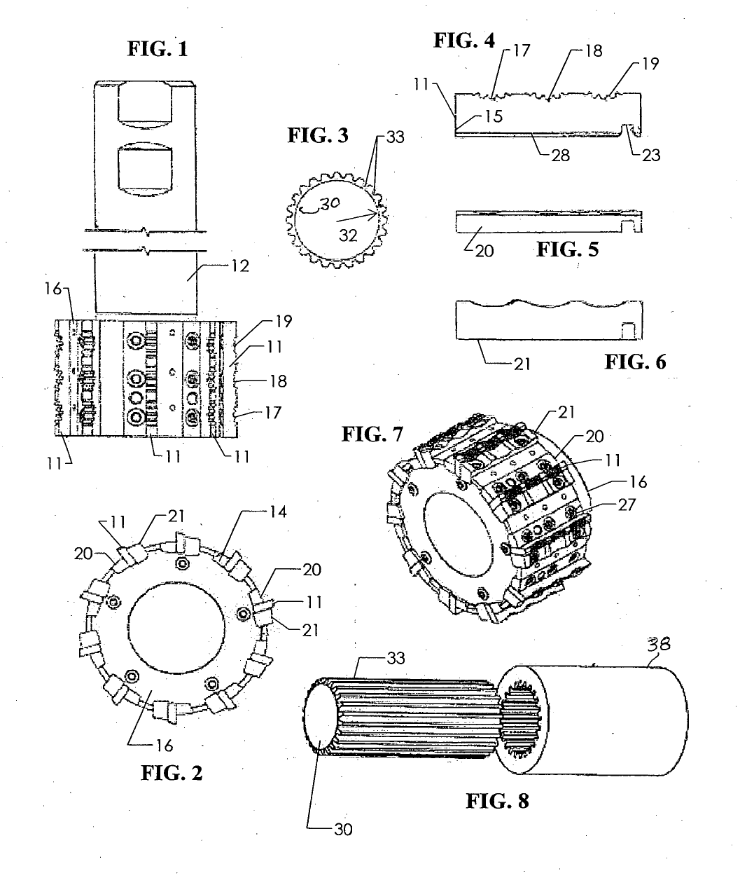

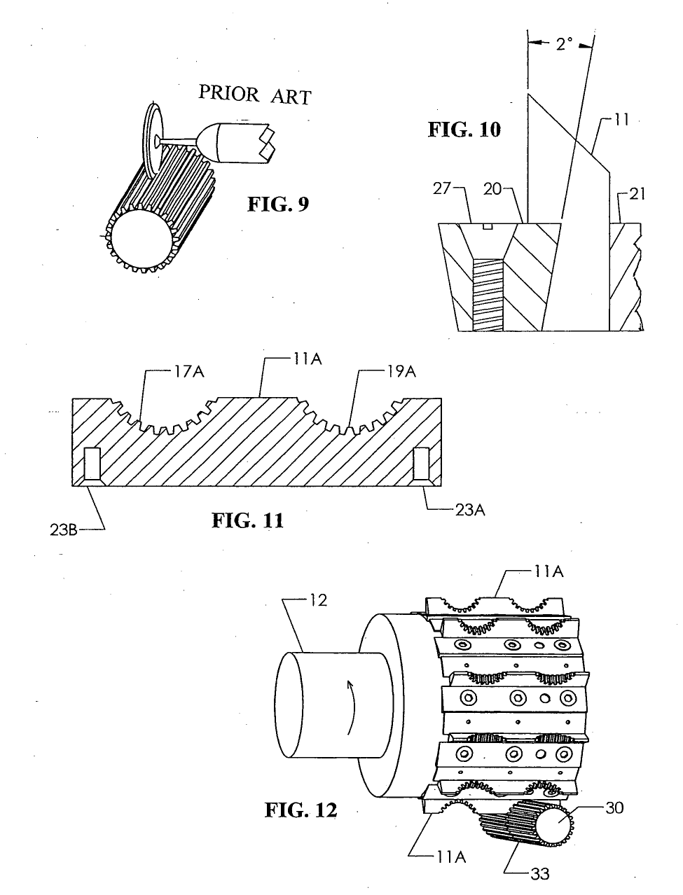

FIG. 1 shows the replaceable inventive inserts 11 mounted on the inventive tool holder 12. The tool holder 12 may be generally of the type of tool holder disclosed in U.S. Pat. No. 6,457,381 issued to the same inventors hereof, and is incorporated herein by reference. Tool holder 12 is designed to receive and mount a plurality of the inventive inserts 11 in respective recesses 14 (see FIG. 2) formed on the free end of a standard type shank 16 on tool holder 12. In one of the embodiments of the invention described herein and as shown in FIGS. 2 and 7, a total of ten groups/groupings of inserts are mounted on shank 16. FIG. 4 shows a side view of one of the inserts 11 which inserts are made of carbide material; each insert comprises an essentially rectangular bar 15, see FIG. 4. In one embodiment, the dimensions of an inserts are 1.5 inches in length, ⅜ inches in height and ⅛ inch width. The cutting edges of the inserts 11 are positioned on shank 16 to extend radially outwardly of the periphery of the shank, see FIG. 2 which shows an end view of the inserts 11, as mounted on the shank 16 of the tool holder.

A keying slot 23, see FIG. 4, is formed in each of the inserts 11 to engage a respective positioning shoulder in shank 16. Also, for ease in assembly, the edges of the bar forming the insert 11 may have slightly beveled edges as at 28.

FIGS. 1 and 4 most clearly show the cutting projections or teeth of insert 11. In the embodiment of insert 11 shown in the FIGS. 1, 4 and 7, each of the inserts includes three sets of teeth 17, 18 and 19. Each set of teeth is formed in an arc of a circle, and each set of teeth mills multiple splines concurrently. The teeth are formed and arranged to mill a selected size and shape of splines on a rod or shaft 33 having a corresponding radius, see FIG. 3.

As noted above, FIG. 4 shows that each set of teeth 17, 18 and 19 in the inserts 11 is formed to have its cutting edges or milling contour form the arc of a circle. Referring again to FIG. 3, each set of teeth is designed to form an arc of a circle having a radius 32 and a contour that corresponds to the radius of the round rod material 30 being milled. In the embodiment shown in FIGS. 1 and 7, three (3) splines 33 are milled concurrently by the inserts, although more or less splines could be milled concurrently.

As is described in U.S. Pat. No. 7,425,108, issued on Sep. 16, 2008 to the same inventors herein and titled Method for Milling Splines, which patent is incorporated herein by reference, the rod 30 being milled to form the splines 33 is held in a stationary position by known types of spindles. The tool holder 12 and shank 16 with inserts 11 are positioned to be normal (perpendicular) to the longitudinal axis of the rod material 30 that is being milled. Accordingly, during each sub-operation of a CNC (computer numerical control) machine and as the rotating tool holder 12 is driven to mill the material, one of the sets of inserts 17 or 19 rough mills a set of three splines 33 in rod 30.

The inserts 11 are mounted on tool holder 12 to have teeth set 17 at the end of the distal end of shank 16 to provide a first or rough milling of the grooves forming splines 33. The CNC machine on which the tool holder 12 is mounted moves the rotating inserts 11 to cause the set of teeth make a milling pass in a perpendicular direction relative to the longitudinal axis of rod 30 thereby causing three splines 33 to be milled concurrently on the rod 30. Next, the rod 30 is repositioned or indexed, that is turned, by CNC machine. The tool holder 12 is returned to an initial position and the process is repeated to rough mill a second set of three splines 33. The process is continuously repeated to mill three splines 33 at a time until the full complement of splines on the circumference of the rod 30 is milled. Next, the tool holder 12 is positioned by the CNC machine such that teeth set 18 initiate the finish milling for three of the rough milled splines concurrently. A similar sequence or operation of the CNC machine as described above is programmed to provide the finished milling. A finished rod 30 with an involute spline is indicated in FIG. 8.

FIG. 10 depicts another important concept of the invention wherein the insert 11 is notched inwardly at a slight angle of about two (2) degrees so that the associated wedge 20 can be positioned in place by screw 27 to more securely hold the insert. As can bee clearly seen from FIG. 10, the bottom part of insert is secured more tightly by the wedge 29 and prevented from moving upwardly. The stresses on the insert 1 lare increased considerably when multiple splines are milled concurrently hence this configuration provides additional holding power for or on insert 11.

Various modes or sequence for the milling process can be used, the principal concept being that multiple splines are milled concurrently. In the embodiment of FIG. 1, the sets of teeth 17 and 19 at either end of insert 11 provide a first or rough milling cut for forming splines 33. Set 19 is used after the set 17 is worn or teeth are broken. The CNC machine is easily programmed to move this second set of teeth 19 to make the milling cuts on the rod material. This capability of making more than one set of rough milling teeth on one insert essentially provides a double life or usage for insert 11.

The center set of teeth 18 which provides a fine or finishing cut, generally does not undergo the high degree of stress or wear of the rough cut sets of teeth 17 and 19. The fine milling sets 18 normally last or are useful for more than double the number of operations compared to the teeth making the rough cuts. Hence only one set of fine milling teeth 18 are formed on each insert 11.

FIG. 11 shows another embodiment of the insert labeled 11A wherein the insert has only two sets of cutting teeth 17A and 19A. The two sets may be identical or one set can be the roughing set and the other set the finishing set. In this embodiment two keying slots 23A and 23B are formed on respective opposite ends of the insert 11A. The keying slots enable the insert 11A to be reversed in position to cut in either the right and left handed rotation of the tool 12, or to use the insert 11A in reversed position if desired such as if the one edge or tip of the cutting teeth of the insert 11A has been damaged.

Refer now to FIG. 2 as well as to FIGS. 1 and 7. The inventive inserts 11 are mounted in respective recesses 14 spaced around the circumference of shank 16 and in respective groupings. Each grouping of inserts comprises an inventive insert 11, a wedge 20 and a support member 21 for the insert. FIG. 5 shows a side view of wedge 20 which is an elongated steel bar of substantially the same length as insert 11, and is of a reduced height relatively to insert 11 and is affixed to the shank 16 by suitable screws 27. FIG. 7 shows a side view of support member 21 which is also a rectangular bar of essentially the same length of the upper edge of insert 11 and is of slightly reduced height and contour as the insert. As seen in FIG. 2, the width of support 21 is essentially twice the width of insert 11. Support member 21 is made of steel and provides a strong support (brace) for the insert 11. This support for insert 11 is provided due to the fact the insert 11 undergoes significant stress because the insert is milling multiple cuts in the material being milled. That is, more stress is developed on an insert when the insert is making multiple cuts on the material as compared to the stress developed when an insert is making a single cut or pass on the material.

FIG. 5 is an isometric view of the inserts 11 mounted on the tool holder shank 16. Shank 16 includes elongated spaced recesses or slots 14 (see also FIG. 2) radially spaced on shank 16 for receiving inserts 11 and associated wedges 20 and support members 21. The tool holder shank 16 can be a unit having standard shaped recesses, and the wedges 20 and support members 21 can be dimensioned dependent on the shape and size of the inserts being used. Thus, the reduction in material and inventory of tool holders is readily apparent. The foregoing features, in addition to the fact that the inserts having at least two sets of rough milling teeth effectively provide a double use of the inserts, resulting in substantial savings and convenience for the user. Another principal advantage of the invention is that inserts do not have to be changed as often as is necessary with previous inserts and this provides a significant labor savings. Stoppage of the CNC machine to change inserts results in loss in production. Thus, the inventive inserts and universal tool holder provide improved features and advantages for the user.

FIG. 12 depicts the inventive inserts 11A in a position cutting multiple splines 33 in a rod 30.

While the invention has been particularly shown and described with reference to preferred embodiments thereof, it will be understood by those skilled in the art that various changes in form and details may be made therein without departing from the spirit and scope of the invention.

1. A replaceable insert for mounting on a tool holder for concurrently thread milling multiple involute splines on round material of a given radius, said insert comprising in combination,
a) an elongated rectangular bar having at least three sets of milling teeth,
each set of teeth having their cutting edges formed in the arc of a circle corresponding to the arc of the circle said round material on which the splines are to be cut;
b) said first and second sets of teeth being formed to rough mill said splines; and
c) said third set of teeth being formed to finish mill the splines which one of the other sets of teeth has rough milled.

2. An insert as in claim 1 wherein said first and second sets of milling teeth are formed on opposite ends of said elongated bar insert and said third set of milling teeth are formed in essentially the middle of said bar insert.

3. An insert as in claim 1 wherein three splines are milled concurrently.

4. A tool holder for mounting replaceable elongated inserts for concurrently thread milling multiple involute splines on round material of a given radius,
a) said tool holder comprising a shaft, and a shank on the end of said shaft; elongated recesses formed longitudinally on the periphery of said shank for receiving and mounting said inserts;
b) said inserts each having a plurality of milling teeth;
c) each set of teeth having their cutting edges formed in the arc of a circle corresponding to the arc of the circle said round material on which the splines are to be cut; and
d) said elongated recesses in said insert width for receiving and mounting a respective grouping of at least three separate securing components.

5. An insert as in claim 4 wherein said insert is one of a plurality of inserts mounted in a universal tool holder suitable for mounting inserts of different configuration in respective recesses in said tool holder and wherein an insert is mounted in a respective recess as one component of a grouping comprising a wedge suitably affixed to said tool holder in said respective recess as by screws, and a support member of similar configuration as said insert mounted in said respective tool holder recess to brace said insert against the forces and stress developed in said milling operation.

6. An insert as in claim 5 wherein said insert is undercut at an angle to enable a portion of a wedge to bear against the under cut to more securely hold said insert in position.

7. A tool holder for mounting replaceable elongated inserts for concurrently thread milling multiple involute splines on round material of a given radius,
a) said tool holder comprising a shaft, and a shank on the end of said shaft; elongated recesses formed longitudinally on the periphery of said shank for receiving and mounting said inserts;
b) said inserts each having multiple sets of milling teeth, each set of teeth having their cutting edges formed in the arc of a circle corresponding to the arc of the circle said round material on which the splines are to be cut;
c) said elongated recesses in said insert having a selected standard width for receiving and mounting a respective grouping of components including an insert, a wedge and a supporting member for said insert;
d) said standard dimension of said recesses allowing the overall width dimensions of each member of said grouping to be varied so long as the total width of components conforms to the width dimension of said recesses.
